(19) United States
(12) Patent Application Publication
(10) Pub. No.: US 2025/0329943 A1
(43) Pub. Date: Oct. 23, 2025

(54) TERMINAL-ATTACHED ELECTRIC WIRE AND WIRE HARNESS

(71) Applicant: Yazaki Corporation, Tokyo (JP)

(72) Inventors: Hirohito NAKATA, Makinohara-shi (JP); Ryosuke HARA, Makinohara-shi (JP)

(73) Assignee: Yazaki Corporation, Tokyo (JP)

(21) Appl. No.: 19/081,136

(22) Filed: Mar. 17, 2025

(30) Foreign Application Priority Data
Apr. 22, 2024 (JP) 2024-069193

(51) Int. Cl. H01R 4/02; H01B 7/00

(52) U.S. Cl. CPC H01R 4/023; H01B 7/0045

(57) ABSTRACT

A terminal-attached electric wire that can achieve sufficient bonding strength in the connection between the end portion of an electric wire and a terminal component, and provide a wire harness that includes such a terminal-attached electric wire. In a terminal-attached electric wire, a fused connection portion for bonding a conductor-exposed portion of an electric wire and a bonding portion of a terminal component to each other has such a shape that, in a cross section that passes through an extension center axis of the conductor-exposed portion and intersects with a placement surface of the bonding portion, a contour line of the fused connection portion does not pass through an inside of an arc-shaped area having a center at an end portion located near an edge on an electric wire extension side.

### TECHNICAL FIELD

The present invention relates to a terminal-attached electric wire including an electric wire an end portion of which is bonded to a terminal component, and to a wire harness including such a terminal-attached electric wire.

### BACKGROUND

Conventionally, terminal-attached electric wires including electric wires, the end portions of which are bonded to terminal components, have been widely used (see, for example, Patent Document 1). In the terminal-attached electric wire described in Patent Document 1, the end portion of the electric wire is bonded to the terminal component by crimping. However, there are also terminal-attached electric wires including electric wires, the end portions of which are fusion-bonded to terminal components by, for example, laser welding.

### RELATED ART

### Patent Document

Patent Document 1: JP2007-59304A

### SUMMARY OF THE INVENTION

### Problem to be Solved by the Invention

Regarding fusion-bonded terminal-attached electric wires, it is not always clear what type of bonding state between the end portion of an electric wire and a terminal component is required to obtain sufficient bonding strength, and currently a scope of improvement can be associated with the bonding strength.

Therefore, in view of the above-described problems, it is an object of the present invention to provide a terminal-attached electric wire that can achieve sufficient bonding strength in the connection between the end portion of an electric wire and a terminal component, and to provide a wire harness that includes such a terminal-attached electric wire.

### Solution to Problem

In order to achieve the above object, a terminal-attached electric wire includes: an electric wire made by coating a conductor portion, constituted by a plurality of strands twisted together, with a resin coating, the electric wire including a conductor-exposed portion at one end portion where the conductor portion extends in an exposed state from the resin coating; a terminal component made of a conductive metal and provided with a bonding portion onto which the conductor-exposed portion is placed and fusion-bonded; and a fused connection portion in which the conductor-exposed portion and the bonding portion are at least partially melted and integrated to bond the conductor-exposed portion and the bonding portion to each other, the fused connection portion having such a shape that, in a cross section that passes through an extension center axis of the conductor-exposed portion and intersects with a placement surface of the bonding portion for the conductor-exposed portion, a contour line of the fused connection portion does not pass through an inside of an arc-shaped area having a center at an end portion on the placement surface in the cross section near an edge of the placement surface on an electric wire extension side, the arc-shaped area having a radius that is a length, in an orthogonal direction to the placement surface, obtained by subtracting a thickness of one of the plurality of strands from a distance between the center and an outer surface of the conductor-exposed portion.

Also, in order to achieve the above object, a wire harness includes a plurality of above-described terminal-attached electric wires, and a connector housing that is a housing member made of insulating resin, to which the plurality of terminal-attached electric wires are combined, the connector housing being provided with a plurality of terminal accommodation chambers each formed in a tubular shape, terminal components of the plurality of terminal-attached electric wires are housed in a one-to-one relationship in the respective terminal accommodation chambers.

### Advantageous Effects of the Invention

According to the terminal-attached electric wire and the wire harness described above, a sufficient bonding strength can be achieved in the connection between the end portion of an electric wire and a terminal component.

### BRIEF DESCRIPTION OF THE DRAWINGS

FIG. 1 is an exploded perspective view illustrating a wire harness according to one embodiment.

FIG. 2 is an enlarged view illustrating an exposed conductor portion of an electric wire illustrated in FIG. 1, placed on a placement surface of a bonding portion of a terminal component.

FIG. 3 is a three-view projection illustrating the electric wire and the terminal component illustrated in FIG. 2.

FIG. 4 is a schematic diagram illustrating the shape of the fused connection portion illustrated in FIGS. 2 and 3.

FIGS. 5A and 5B illustrate a comparative example, presented in a side view and a partial cross-sectional view similar to FIG. 4, in comparison to the shape of the fused connection portion illustrated in FIG. 4.

### DETAILED DESCRIPTION OF THE EXEMPLARY EMBODIMENT

Hereinafter, one embodiment of a terminal-attached electric wire and a wire harness is described.

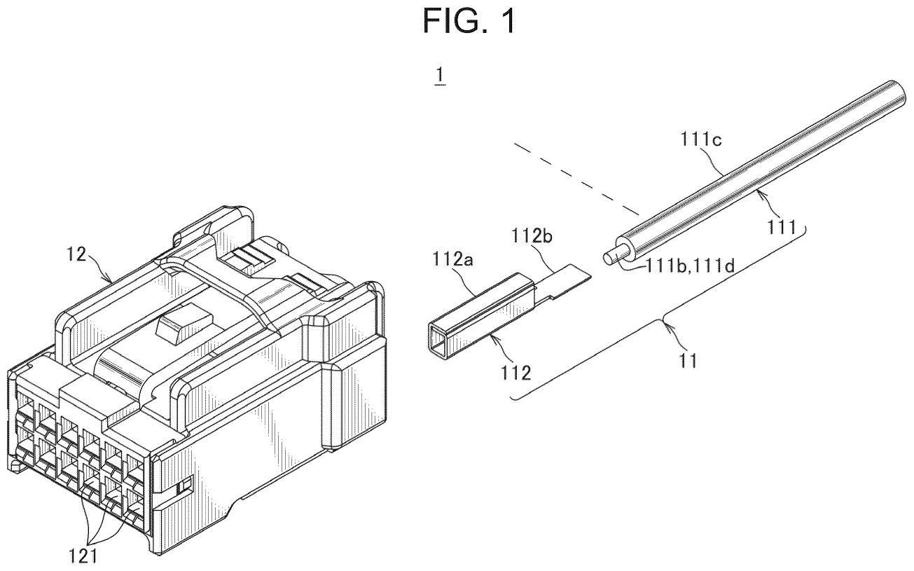

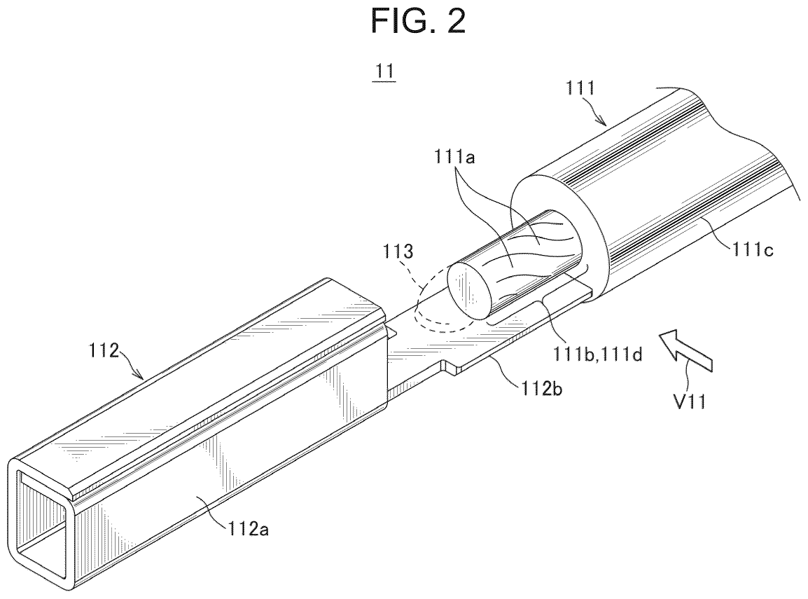

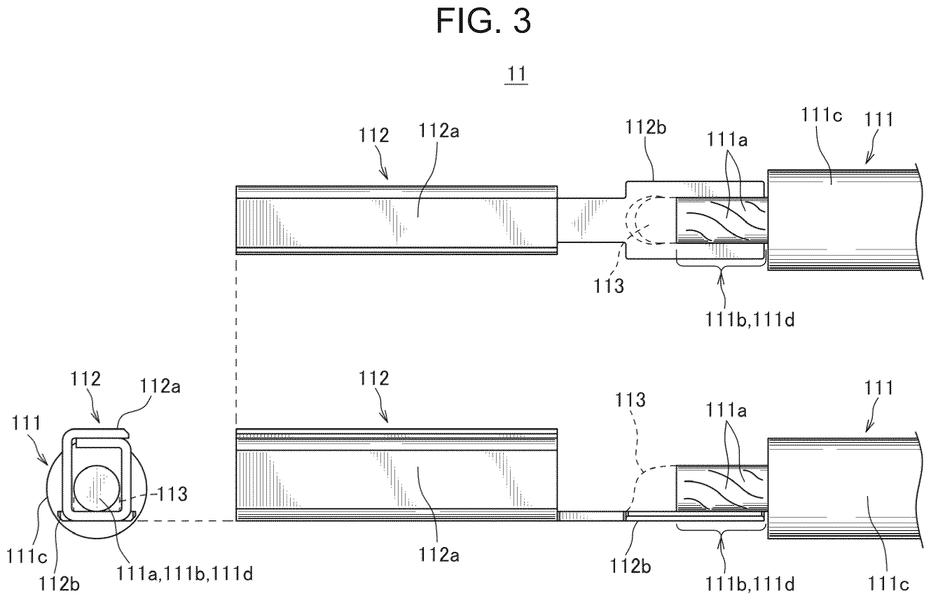

FIG. 1 is an exploded perspective view illustrating a wire harness according to one embodiment. FIG. 2 is an enlarged view illustrating an exposed conductor portion of an electric wire illustrated in FIG. 1, placed on a placement surface of a bonding portion of a terminal component. FIG. 3 is a three-view projection illustrating the electric wire and the terminal component illustrated in FIG. 2.

The wire harness 1 according to the present embodiment is intended to be mounted on, for example, an automobile or the like to connect various devices, and includes a plurality of terminal-attached electric wires 11 and a connector housing 12. Each terminal-attached electric wire 11 has a terminal component 112 serving as a female connector terminal, which is fusion-bonded to an end portion of the electric wire 111 by, for example, laser welding. The connector housing 12 is a housing member made of insulating resin in the shape of a rectangular block, to which a plurality of terminal-attached electric wires 11 are combined. The connector housing 12 is provided with a plurality of terminal accommodation chambers 121 each formed in a tubular shape, and the terminal components 112 of the plurality of terminal-attached electric wires 11 are housed in a one-to-one relationship in the respective terminal accommodation chambers 121.

The electric wire 111 of the terminal-attached electric wire 11 is a coated electric wire made by coating a conductor portion 111b, constituted by a plurality of strands 111a twisted together, with a resin coating 111c. The electric wire 111 has a conductor-exposed portion 111d at one end portion where the conductor portion 111b extends in an exposed state from the resin coating 111c.

The terminal component 112 serving as the female connector terminal is a component made through sheet metal processing, provided with: a mating portion 112a made of a conductive metal in a rectangular tubular shape to which a mating male pin terminal is mated; and a bonding portion 112b onto which the conductor-exposed portion 111d of the electric wire 111 is placed and fusion-bonded. The bonding portion 112b is a metal plate portion that extends in a flat plate shape in an expanded manner from the bottom plate portion of the mating portion 112a on the opposite side to the mating side. The conductor-exposed portion 111d, which is placed on the bonding portion 112b, is fusion-bonded to the bonding portion 112b. As a result, at least a portion of the conductor-exposed portion 111d and the bonding portion 112b are melted and integrated to form a fused connection portion 113 that bonds the conductor-exposed portion 111d and the bonding portion 112b to each other. In this case, the fused connection portion 113 is formed in the shape described below.

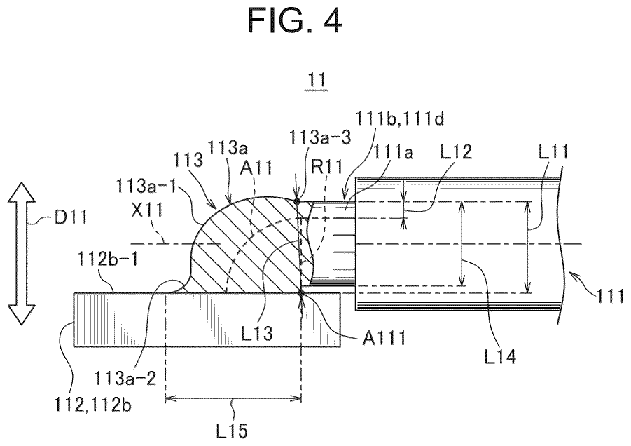

FIG. 4 is a schematic diagram illustrating the shape of the fused connection portion illustrated in FIGS. 2 and 3. FIG. 4 is a side view and partial cross section, as seen from the direction of arrow V11 in FIG. 2, illustrating the fused connection portion 113 of the terminal-attached electric wire 11, i.e., a bonding part between the conductor-exposed portion 111d of the electric wire 111 and the bonding portion 112b of the terminal component 112. In this case, the partial cross section is a cross section that passes through the extension center axis X11 of the conductor-exposed portion 111d and intersects with the placement surface 112b-1 of the bonding portion 112b for the conductor-exposed portion 111d.

As illustrated in FIG. 4, the fused connection portion 113 is formed so that a contour line 113a in the cross section does not pass through the inside of an arc-shaped area A11 as explained below. The arc-shaped area A11 has a center A111 at an end portion located on the placement surface 112b-1 in the cross section of the fused connection portion 113 near the edge of the placement surface 112b-1 on the electric wire extension side. The arc-shaped area A11 is an area in an arc shape with a radius R11, as explained below, around the center A111. The radius R11 of the arc-shaped area A11 is a distance, in the orthogonal direction D11 to the placement surface 112b-1, which is obtained by subtracting a thickness L12 of one strand 111a from a distance L11 between the center A111 and the outer surface of the conductor-exposed portion 111d.

In addition, the contour line 113a of the fused connection portion 113 in the above cross section extends toward the placement surface 112b-1 on an opposite side to the electric wire extension side by tracing a convex curve 113a-1 toward the opposite side, and then reaches the placement surface 112b-1 by tracing a rounded-corner concave shape 113a-2. Also, a distance L13 between the center A111 and a closest point 113a-3 on the contour line 113a that is closest to the center A111 is 70% or more of an outer diameter L14 of the conductor portion 111b. Furthermore, a bonding length L15, along the extension center axis X11, of the fused connection portion 113 with the placement surface 112b-1 is longer than the outer diameter L14 of the conductor portion 111b.

The terminal-attached electric wire 11 and the wire harness 1 according to the embodiment described above can provide the effects described below. In the present embodiment, the conductor-exposed portion 111d at the end portion of electric wire 111 and the bonding portion of the terminal component 112 are bonded by the fused connection portion 113 in which the conductor-exposed portion 111d and the bonding portion 112b are at least partially melted and integrated. Furthermore, the contour line 113a of the fused connection portion 113 in the above cross section has a shape that does not pass through the inside of the arc-shaped area A11 around the center A111 with the radius R11 that is obtained by subtracting the thickness L12 of one strand 111a from the distance L11 between the center A111 and the outer surface of the conductor-exposed portion 111d. This arc-shaped area A11 indicates that, for the conductor-exposed portion 111d, the fused connection portion 113 has a sufficient volume and the bonding length L15 for bonding with the placement surface 112b-1 to provide adequate bonding strength.

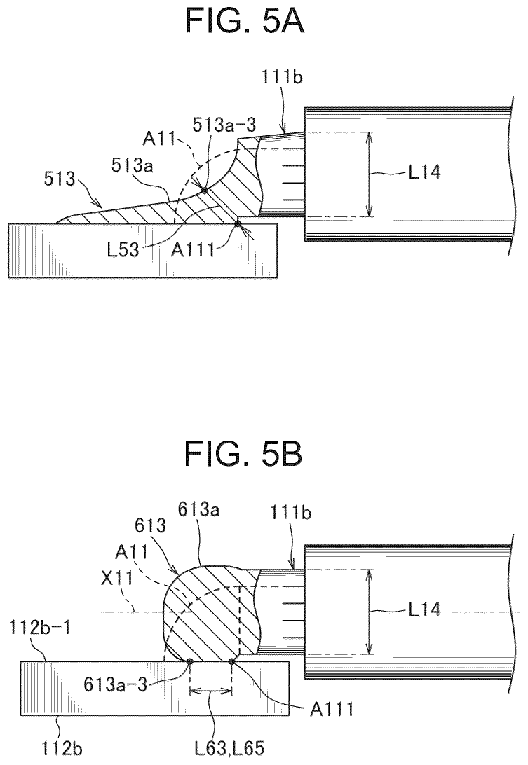

FIGS. 5A and 5B illustrate a comparative example, presented in a side view and a partial cross-sectional view similar to FIG. 4, in comparison to the shape of the fused connection portion illustrated in FIG. 4. FIG. 5A illustrates a first comparative example, and FIG. 5B illustrates a second comparative example. In FIGS. 5A and 5B, components equivalent to those illustrated in FIG. 4 are given the same reference numerals as those in FIG. 4 only when they are necessary for explanation, and duplicate explanations of those equivalent components are omitted below.

In the first comparative example illustrated in FIG. 5A, the fused connection portion 513 collapses and flows. As a result, the fused connection portion 513 has such a shape that a contour line 513a passes through the inside of the arc-shaped area A11 in the cross section of the fused connection portion 513. The fused connection portion 513 in this first comparative example lacks volume to provide adequate bonding strength. Furthermore, in this first comparative example, due to the collapse of the fused connection portion 513, a distance L53 from a closest point 513a-3 on the contour line 513a to the center A111 is less than 70% of the outer diameter L14 of the conductor portion 111b. The fused connection portion 513 in the first comparative example is further deficient in volume in that the distance L53 from the closest point 513a-3 on the contour line 513a to the center A111 is short.

In the second comparative example illustrated in FIG. 5B, the wettability of a fused connection portion 613 with the placement surface 112b-1 of the bonding portion 112b is insufficient, resulting in a gap between the fused connection portion 613 and the placement surface 112b-1. In the gap, a contour line 613a in the cross section passes through the inside of the arc-shaped area A11. In the second comparative example, the fused connection portion 613 has a chip in the gap, and the volume required to exert sufficient bonding strength is insufficient. In addition, in this second comparative example, the edge of the gap is a closest point 613a-3, and a distance L63 from this closest point 613a-3 to the center A111 is less than 70% of the outer diameter L14 of the conductor portion 111b. Furthermore, the distance L63 from the closest point 613a-3 to the center A111 is also a bonding length L65 of the fused connection portion 613 for bonding with the placement surface 112b-1 along the extension center axis X11, and this bonding length L65 is shorter than the outer diameter L14 of the conductor portion 111b. The fused connection portion 613 according to the second comparative example has even less bonding strength due to the short distance L63 and the short bonding length L65 between the closest point 613a-3 and the center A111.

In contrast, according to the embodiment described above, the contour line 113a of the fused connection portion 113 in the cross section does not pass through the inside of the arc-shaped area A11, and therefore can ensure a sufficient volume and the bonding length L15. Furthermore, by providing the fused connection portion 113 as explained above, sufficient bonding strength can be obtained for the bonding between the end portion of the electric wire 111 and the terminal component 112.

In the present embodiment, the contour line 113a reaches the placement surface 112b-1 by tracing the convex curve 113a-1 and the rounded-corner concave shape 113a-2. In this configuration, the fused connection portion 113 has a sufficient volume because the contour line 113a traces the convex curve 113a-1. Furthermore, because the contour line 113a reaches the placement surface 112b-1 by tracing the rounded-corner concave shape 113a-2, the fused connection portion 113 is integrated with the placement surface 112b-1 with sufficiently smooth continuity. In view of these points, the above configuration further improves the bonding strength between the end portion of the electric wire 111 and the terminal component 112.

Furthermore, in the present embodiment, the distance L13 between the center A111 and the closest point 113a-3 on the contour line 113a that is closest to the center A111 has a length that is 70% or more of the outer diameter L14 of the conductor portion 111b. In this configuration, the distance L13 between the center A111 of the arc-shaped area A11 and the closest point 113a-3 on the contour line 113a indicates the degree of volume reduction when the fused connection portion 113 has a partially crushed shape. Furthermore, when the distance L13 is set to a length that is 70% or more of the outer diameter L14 of the conductor portion 111b, volume reduction is alleviated, and the bonding strength between the end portion of the electric wire 111 and the terminal component 112 can be further improved.

Furthermore, in the present embodiment, the bonding length L15 of the fused connection portion 113 for bonding with the placement surface 112b-1 is longer than the outer diameter L14 of the conductor portion 111b. According to this configuration, a more sufficient length can be obtained as the bonding length L15 between the fused connection portion 113 and the placement surface 112b-1, and therefore the bonding strength between the end portion of the electric wire 111 and the terminal component 112 can be further improved.

The above-described embodiment merely shows typical forms of the terminal-attached electric wire and the wire harness. The terminal-attached electric wire and the wire harness are not limited thereto, and can be modified in various ways.

For example, in the above-described embodiment, the wire harness 1 that is mounted on an automobile or the like to connect various devices is given as an example of a wire harness. However, the wire harness is not limited thereto, and the specific object to which it is mounted is not particularly limited.

Furthermore, in the above-described embodiment, the terminal-attached electric wire 11 having the electric wire 111, the end portion of which is bonded to the terminal component 112 of the female type, is given as an example of a terminal-attached electric wire. However, the terminal-attached electric wire is not limited thereto, and may have a male pin terminal bonded to an end portion of the electric wire, or may be bonded with a terminal other than a connector terminal, such as a round terminal.

Furthermore, in the above-described embodiment, the connector housing 12 having the rectangular block-like appearance and provided with the plurality of terminal accommodation chambers 121 is given as an example of a connector housing of a wire harness. However, the connector housing is not limited thereto, and the specific external shape of the connector housing may be any shape as long as the terminal components of the multiple terminal-attached electric wires are housed in a one-to-one relationship in the respective terminal accommodation chambers.

Here, in the above-described embodiment, the fused connection portion 113 having the contour line 113a reaching the placement surface 112b-1 by tracing the convex curve 113a-1 and the rounded-corner concave shape 113a-2 is given as an example of a fused connection portion. However, the fused connection portion is not limited thereto, and the specific shape of the contour line is not important as long as it has a shape that does not pass through the inside of the arc-shaped area explained above. However, as described above, the bonding strength between the end portion of the electric wire 111 and the terminal component 112 can be further improved by the contour line 113a tracing the convex curve 113a-1 and the rounded-corner concave shape 113a-2.

Furthermore, in the above-described embodiment, the fused connection portion 113 in which the distance L13 between the center A111 and the closest point 113a-3 on the contour line 113a is 70% or more of the outer diameter L14 of the conductor portion 111b is given as an example of a fused connection portion. However, the fused connection portion is not limited thereto, and as long as the fused connection portion has such a shape that does not pass through the inside of the arc-shaped area as explained above, the distance between the center and the closest point of the contour line may be less than 70% of the outer diameter of the conductor portion. However, as described above, the bonding strength between the end portion of the electric wire 111 and the terminal component 112 can be further improved when the distance L13 between the center A111 and the closest point 113a-3 of the contour line 113a is set to 70% or more of the outer diameter L14 of the conductor portion 111b.

Furthermore, in the above-described embodiment, the bonding length L15 of the fused connection portion 113 for bonding with the placement surface 112b-1 is longer than the outer diameter L14 of the conductor portion 111b. However, the fused connection portion is not limited thereto, and the bonding length may be shorter than the outer diameter of the conductor portion. However, as described above, the bonding strength between the end portion of the electric wire 111 and the terminal component 112 can be further improved when the bonding length L15 is longer than the outer diameter L14 of the conductor portion 111b.

### LIST OF REFERENCE SIGNS

1 wire harness
11 terminal-attached electric wire
12 connector housing
111 electric wire
111a strand
111b conductor portion
111c resin coating
111d conductor-exposed portion
112 terminal component
112a mating portion
112b bonding portion
112b-1 placement surface
113 fused connection portion
113a contour line
113a-1 convex curve
113a-2 rounded-corner concave shape
113a-3 closest point
121 terminal accommodation chamber
A11 arc-shaped area
A111 center
D11 orthogonal direction
L11 distance between center and outer surface of conductor-exposed portion
L12 thickness of one strand
L13 distance between center and closest point on contour line
L14 outer diameter of conductor portion
L15 bonding length
R11 radius
X11 extension center axis

What is claimed is:

1. A terminal-attached electric wire comprising:
an electric wire made by coating a conductor portion, constituted by a plurality of strands twisted together, with a resin coating, the electric wire including a conductor-exposed portion at one end portion where the conductor portion extends in an exposed state from the resin coating;
a terminal component made of a conductive metal and provided with a bonding portion onto which the conductor-exposed portion is placed and fusion-bonded; and
a fused connection portion in which the conductor-exposed portion and the bonding portion are at least partially melted and integrated to bond the conductor-exposed portion and the bonding portion to each other, the fused connection portion having such a shape that, in a cross section that passes through an extension center axis of the conductor-exposed portion and intersects with a placement surface of the bonding portion for the conductor-exposed portion, a contour line of the fused connection portion does not pass through an inside of an arc-shaped area having a center at an end portion on the placement surface in the cross section near an edge of the placement surface on an electric wire extension side, the arc-shaped area having a radius that is a length, in an orthogonal direction to the placement surface, obtained by subtracting a thickness of one of the plurality of strands from a distance between the center and an outer surface of the conductor-exposed portion.

2. The terminal-attached electric wire according to claim 1, wherein the contour line extends toward the placement surface on an opposite side to the electric wire extension side by tracing a convex curve toward the opposite side, and then reaches the placement surface by tracing a rounded-corner concave shape.

3. The terminal-attached electric wire according to claim 1, wherein a distance between the center and a closest point on the contour line that is closest to the center is 70% or more of an outer diameter of the conductor portion.

4. The terminal-attached electric wire according to claim 1, wherein a bonding length of the fused connection portion for bonding with the placement surface along the extension center axis is longer than an outer diameter of the conductor portion.

5. A wire harness comprising:
a plurality of terminal-attached electric wires as claimed in claim 1; and
a connector housing that is a housing member made of insulating resin, to which the plurality of terminal-attached electric wires are combined, the connector housing being provided with a plurality of terminal accommodation chambers each formed in a tubular shape, terminal components of the plurality of terminal-attached electric wires are housed in a one-to-one relationship in the respective terminal accommodation chambers.

6. A wire harness comprising:
a plurality of terminal-attached electric wires as claimed in claim 2; and
a connector housing that is a housing member made of insulating resin, to which the plurality of terminal-attached electric wires are combined, the connector housing being provided with a plurality of terminal accommodation chambers each formed in a tubular shape, terminal components of the plurality of terminal-attached electric wires are housed in a one-to-one relationship in the respective terminal accommodation chambers.

7. A wire harness comprising:
a plurality of terminal-attached electric wires as claimed in claim 3; and
a connector housing that is a housing member made of insulating resin, to which the plurality of terminal-attached electric wires are combined, the connector housing being provided with a plurality of terminal accommodation chambers each formed in a tubular shape, terminal components of the plurality of terminal-attached electric wires are housed in a one-to-one relationship in the respective terminal accommodation chambers.

8. A wire harness comprising:
a plurality of terminal-attached electric wires as claimed in claim 4; and
a connector housing that is a housing member made of insulating resin, to which the plurality of terminal-attached electric wires are combined, the connector housing being provided with a plurality of terminal accommodation chambers each formed in a tubular shape, terminal components of the plurality of terminal-attached electric wires are housed in a one-to-one relationship in the respective terminal accommodation chambers.
